(19) United States
(12) Patent Application Publication
(10) Pub. No.: US 2026/0352896 A1
(43) Pub. Date: Nov. 5, 2026

(54) METHOD AND APPARATUS FOR PROCESSING STATE IDENTIFIER OF LIVE STREAMING ROOM, DEVICE, AND MEDIUM

(71) Applicant: BEIJING ZITIAO NETWORK TECHNOLOGY CO., LTD., Beijing (CN)

(72) Inventors: Rusong HUAN, Beijing (CN); Rui ZHANG, Bejing (CN); Liangming LI, Beijing (CN)

(21) Appl. No.: 19/488,541

(22) PCT Filed: May 31, 2024
(86) PCT No.: PCT/CN2024/096806

§ 371 Date: Nov. 26, 2025

(30) Foreign Application Priority Data
May 31, 2023 (CN) 202310637793.7

(51) Int. Cl. H04N 21/2187; H04N 21/84

(52) U.S. Cl. CPC H04N 21/2187; H04N 21/84

(57) ABSTRACT

The present disclosure provides a method and an apparatus for processing a state identifier of a live streaming room, a device, and a storage medium. The method includes: when it is determined that a target live streaming room is switched from an offline state to a live state, sending a liveness probe request to a server, such that the server returns live streaming room information of the target live streaming room based on the liveness probe request; and adjusting a display state of a state identifier of the target live streaming room to a live display state based on the live streaming room information of the target live streaming room.

### CROSS-REFERENCE TO RELATED APPLICATION(S)

The present application claims priority to Chinese Patent Application No. 202310637793.7, filed on May 31, 2023 and entitled “METHOD AND APPARATUS FOR PROCESSING STATE IDENTIFIER OF LIVE STREAMING ROOM, DEVICE, AND MEDIUM”, which is incorporated herein by reference in its entirety.

### FIELD

The present disclosure relates to the field of live streaming technologies, and in particular, to a method and an apparatus for processing a state identifier of a live streaming room, a device, and a medium.

### BACKGROUND

In an existing solution, a manner of processing a state identifier of a live streaming room depends on a viewer's manual refresh. Because a time difference exists between a live time of a live streaming room and a manual refresh time of a viewer, a display state of the state identifier of the live streaming room cannot be updated in time, and a problem that the display state of the state identifier of the live streaming room does not match a real state of the live streaming room is likely to occur, further affecting the live-streaming effect.

### SUMMARY

In order to solve the technical problem described above or at least partially solve the technical problem described above, the present disclosure provides a method and an apparatus for processing a state identifier of a live streaming room, a device, and a medium.

According to a first aspect, the present disclosure provides a method for processing a state identifier of a live streaming room. The method includes:
when it is determined that a target live streaming room is switched from an offline state to a live state, sending a liveness probe request to a server, such that the server returns live streaming room information of the target live streaming room based on the liveness probe request; and
adjusting a display state of a state identifier of the target live streaming room to a live display state based on the live streaming room information of the target live streaming room.

According to a second aspect, the present disclosure provides an apparatus for processing a state identifier of a live streaming room, the apparatus including:
a sending module configured to: when it is determined that a target live streaming room is switched from an offline state to a live state, send a liveness probe request to a server, such that the server returns live streaming room information of the target live streaming room based on the liveness probe request; and
an adjustment module configured to adjust a display state of a state identifier of the target live streaming room to a live display state based on the live streaming room information of the target live streaming room.

According to a third aspect, the present disclosure provides a computer-readable storage medium having instructions stored therein, where the instructions, when executed on a terminal device, cause the terminal device to implement the method described above.

According to a fourth aspect, the present disclosure provides a device, including: a memory, a processor, and a computer program that is stored on the memory and executable on the processor, where the processor, when executing the computer program, implements the method described above.

According to a fifth aspect, the present disclosure provides a computer program product, including a computer program or instructions that, when executed by a processor, implement the method described above.

### BRIEF DESCRIPTION OF THE DRAWINGS

The accompanying drawings herein, which are incorporated into and form a part of the description, illustrate the embodiments in line with the present disclosure and are used in conjunction with the description to explain the principles of the present disclosure.

In order to more clearly illustrate the technical solutions in the embodiments of the present disclosure or in the prior art, the accompanying drawings for describing the embodiments or the prior art will be briefly described below. Apparently, those of ordinary skill in the art may still derive other drawings from these accompanying drawings without creative efforts.

FIG. 1 is a schematic architectural diagram of a system for processing a state identifier of a live streaming room according to an embodiment of the present disclosure;

FIG. 2 is a schematic flowchart of a method for processing a state identifier of a live streaming room according to an embodiment of the present disclosure;

FIG. 3 is a logical schematic diagram of another method for processing a state identifier of a live streaming room according to an embodiment of the present disclosure;

FIG. 4 is a logical schematic diagram of a process of generating a subscription relationship according to an embodiment of the present disclosure;

FIG. 5 is a schematic structural diagram of an apparatus for processing a state identifier of a live streaming room according to an embodiment of the present disclosure; and

FIG. 6 is a schematic structural diagram of a device for processing a state identifier of a live streaming room according to an embodiment of the present disclosure.

### DETAILED DESCRIPTION OF EMBODIMENTS

For a clearer understanding of the above objectives, features and advantages of the present disclosure, the solutions of the present disclosure will be further described below. It should be noted that the embodiments of the present disclosure and features in the embodiments may be combined with each other without conflict.

Many specific details are set forth in the following description to facilitate a full understanding of the present disclosure. However, the present disclosure may also be implemented in other ways different from those described herein. Apparently, the embodiments in the description are only some rather than all of the embodiments of the present disclosure.

With the rapid development of Internet technology, a live streaming system having a live streaming room function has been widely used. A state identifier of a live streaming room is an important viewing entry, and whether a display state of a state identifier of a live streaming room in a live streaming state can be updated in time is a key factor affecting the live-streaming effect.

In the related art, a manner of processing a state identifier of a live streaming room depends on a viewer's manual refresh, and a problem that the display state of the state identifier of the live streaming room does not match a real state of the live streaming room is likely to occur. In a scenario, the display state of the state identifier of the live streaming room is an offline display state, but the real state of the live streaming room is a live state, leading to the problem that the display state of the state identifier of the live streaming room does not match the real state of the live streaming room. This keeps a viewer from perceiving that the live streaming room is already live, which in turn keeps the user from entering the live streaming room by triggering the state identifier, resulting in a reduced live-streaming effect.

In other scenarios, the display state of the state identifier of the live streaming room is a live display state. A viewer wants to enter the live streaming room by triggering the state identifier of the live streaming room, but only finds after entering the live streaming room that the real state of the live streaming room is an offline state, which affects the live streaming viewing experience of the viewer.

In order to improve the live-streaming effect and to enhance the live streaming viewing experience of a viewer, a client may initiate a liveness probe request for a live-streaming status by polling, such that a server determines live streaming room information based on the liveness probe request and pushes the live streaming room information to the client, and then the client adjusts the display state of the state identifier of the live streaming room based on the live streaming room information. However, when initiating the liveness probe request, the client does take into consideration whether or not the live-streaming status of the live streaming room changes, and as a result, the client cannot adjust the display state of the state identifier after initiating the liveness probe request, that is, most liveness probe requests sent by the client are invalid requests, resulting in a waste of request resources.

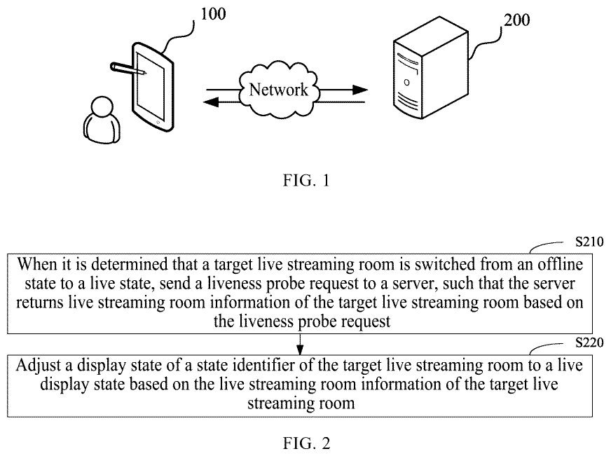

In order to solve the problem described above, FIG. 1 is a schematic architectural diagram of a system for processing a state identifier of a live streaming room according to an embodiment of the present disclosure. As shown in FIG. 1, the system for processing a state identifier of a live streaming room includes a client 100 and a server 200.

First, when determining that a target live streaming room is switched from an offline state to a live state, the client 100 sends a liveness probe request to the server 200, such that the server 200 returns live streaming room information of the target live streaming room based on the liveness probe request. Next, the client 100 adjusts a display state of a state identifier of the target live streaming room to a live display state based on the live streaming room information of the target live streaming room.

Therefore, when perceiving that the target live streaming room is switched from the offline state to the live state, the client adjusts in time the display state of the state identifier of the target live streaming room by sending the liveness probe request to the server. Therefore, the problem that a live streaming room is in fact already live but a state identifier of the live streaming room is in an offline display state is avoided, that is, the problem that the display state of the state identifier of the live streaming room does not match a real state of the live streaming room is avoided, and viewers can conveniently enter the target live streaming room based on the state identifier in the live display state to watch a live stream, thereby improving the live-streaming effect.

In other cases, when the client 100 detects that the target live streaming room is switched from the live state to the offline state and determines that display content of a current interface is not a preview feed of the target live streaming room, the client 100 deletes the live streaming room information of the target live streaming room, and adjusts the display state of the state identifier of the target live streaming room to the offline display state.

In this way, when detecting that the target live streaming room is switched from the live state to the offline state, the client deletes the live streaming room information of the target live streaming room, and adjusts the display state of the state identifier of the target live streaming room to the offline display state. The problem that a viewer enters the live streaming room by triggering the state identifier of the live streaming room, but only finds after entering the live streaming room that the real state of the live streaming room is the offline state is avoided, which is beneficial to improving the live streaming viewing experience of the viewer.

Based on the architecture described above, FIG. 2 is a schematic flowchart of a method for processing a state identifier of a live streaming room according to an embodiment of the present disclosure. As shown in FIG. 2, the method for processing a state identifier of a live streaming room includes the following steps.

At S210, when it is determined that a target live streaming room is switched from an offline state to a live state, a liveness probe request is sent to a server, such that the server returns live streaming room information of the target live streaming room based on the liveness probe request.

In this embodiment, for a live streaming application (e.g., a short video application) having a live streaming room function, a client for the live streaming application determines whether the target live streaming room is switched from the offline state to the live state, and if the target live streaming room is switched from the offline state to the live state, sends the liveness probe request to the server, such that the server returns the live streaming room information of the target live streaming room.

The target live streaming room is a detected live streaming room of any streamer. For example, the target live streaming room is a live streaming room of a beauty streamer, a live streaming room of a travel streamer, or the like.

The liveness probe request is request information for detecting an active state of a service, and is used for obtaining the live streaming room information of the target live streaming room when the target live streaming room is in the active state (i.e., not in a deregistered state, not in an under-review state, etc.).

The live streaming room information is a full address of the live streaming room, and the address contains complex fields.

In order to communicate with the server for a long time, the server and the client may establish a persistent connection, and the client can receive, over the persistent connection, the live streaming room information returned by the server.

At S220, a display state of a state identifier of the target live streaming room is adjusted to a live display state based on the live streaming room information of the target live streaming room.

In this embodiment, the client adjusts the display state of the state identifier of the target live streaming room to the live display state based on the full address of the target live streaming room in the live streaming room information, so that the display state of the state identifier of the target live streaming room is consistent with a real state of the target live streaming room.

The state identifier is indication information indicating a live-streaming status of the live streaming room. Optionally, the state identifier may be a streamer avatar of the target live streaming room, a live streaming post of the target live streaming room, or other information. This is not limited herein.

The live display state is a display state indicating that the target live streaming room is live.

In an embodiment of the present disclosure, optionally, S220 specifically includes: adding a live state element to a basic element of the target live streaming room based on the live streaming room information to form a state identifier corresponding to the live display state.

The basic element is a basic constituent element that forms the state identifier.

It may be understood that if the basic element of the target live streaming room has been stored in the live state or the offline state, the basic element may be directly retrieved and used to generate the state identifier corresponding to the live display state. If the basic element of the target live streaming room has not been stored or has been updated, before the generation of the state identifier corresponding to the live display state, the basic element of the target live streaming room needs to be determined before the state identifier corresponding to the live display state is generated.

In one case, if the state identifier is the streamer avatar of the target live streaming room, the basic element of the state identifier is an avatar of the target live streaming room. The avatar may be a landscape image, a pet photo, etc. This is not limited herein.

In another case, if the state identifier is the live streaming post of the target live streaming room, the basic element of the state identifier is a live streaming room nickname of the target live streaming room.

The live state element is an additional element used for identifying that the target live streaming room is in the live state. Optionally, the live state element may include, but is not limited to, a breathing light with a deformable effect, a “live” field, a color identifier, and another element.

In one case, if the state identifier is the streamer avatar of the target live streaming room and the basic element of the state identifier is the avatar of the target live streaming room, the breathing light with a deformable effect and the “live” field are added to the avatar of the target live streaming room to form the state identifier corresponding to the live display state.

In another case, if the state identifier is the live streaming post of the target live streaming room and the basic element of the state identifier is the live streaming room nickname of the target live streaming room, the “live” field is added after the live streaming room nickname of the target live streaming room and/or a red identifier is added to the live streaming room nickname of the target live streaming room to form the state identifier corresponding to the live display state.

It should be noted that when initiating the liveness probe request, the client takes into consideration the switching of the target live streaming room from the offline state to the live state, the client can adjust the display state of the state identifier of the target live streaming room to the live display state in time after receiving the live streaming room information, thereby avoiding a case that the client fails to adjust the display state of the state identifier of the target live streaming room after sending the liveness probe request. Therefore, liveness probe requests sent by the client are all valid requests, so that a waste of request resources is avoided, thereby improving the utilization of request resources.

An embodiment of the present disclosure provides a method for processing a state identifier of a live streaming room. The method includes: when it is determined whether a target live streaming room is switched from an offline state to a live state, sending a liveness probe request to a server, such that the server returns live streaming room information of the target live streaming room based on the liveness probe request; and adjusting a display state of a state identifier of the target live streaming room to a live display state based on the live streaming room information of the target live streaming room. Therefore, when perceiving that the target live streaming room is switched from the offline state to the live state, the client adjusts in time the display state of the state identifier of the target live streaming room by sending the liveness probe request to the server. Therefore, the problem that a live streaming room is in fact already live but a state identifier of the live streaming room is in an offline display state is avoided, that is, the problem that the display state of the state identifier of the live streaming room does not match a real state of the live streaming room is avoided, and viewers can conveniently enter the target live streaming room based on the state identifier in the live display state to watch a live stream, thereby improving the live-streaming effect.

In another implementation of the present disclosure, when the target live streaming room is switched from the live state to the offline state, a preview feed of target live streaming room is processed, and/or, the display state of the state identifier of the target live streaming room is adjusted to the offline display state.

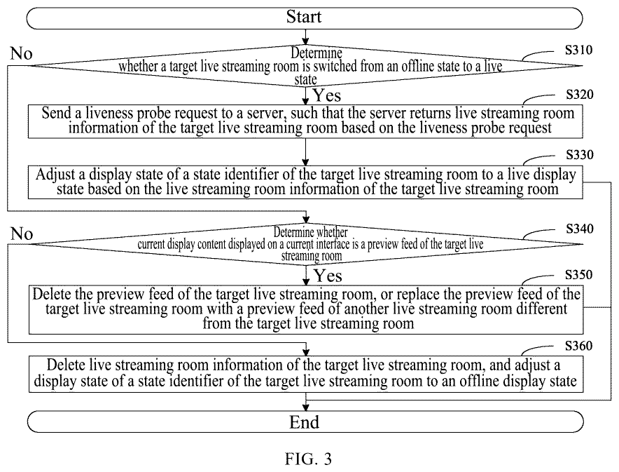

FIG. 3 is a schematic flowchart of another method for processing a state identifier of a live streaming room according to an embodiment of the present disclosure. As shown in FIG. 3, the method for processing the state identifier of the live streaming room includes the following steps.

At S310, whether a target live streaming room is switched from an offline state to a live state is determined.

In this embodiment, a client performs real-time state monitoring on the target live streaming room, specifically, monitors whether the target live streaming room is switched from the offline state to the live state or switched from the live state to the offline state, and adjusts a display state of a state identifier in a manner corresponding to each of the two switching states. Specifically, if determining that the target live streaming room is switched from the offline state to the live state, the client performs S320, or otherwise, performs S340.

At S320, a liveness probe request is sent to a server, such that the server returns live streaming room information of the target live streaming room based on the liveness probe request.

At S330, a display state of a state identifier of the target live streaming room is adjusted to a live display state based on the live streaming room information of the target live streaming room.

S320 and S330 are similar to S210 and S220, and details are not described herein.

At S340, whether current display content displayed on a current interface is a preview feed of the target live streaming room is determined.

The current interface is an interface displaying live streaming content of multiple live streaming rooms on the client. Optionally, the current interface may be a Local page, a Recommendations page, or a Following page. In addition, the current interface may display the display content of one live streaming room in a display manner of a single-column information flow, or may display the display content of multiple live streaming rooms in a display manner of a multi-column information flow. This is not limited herein.

The current display content is editorial content corresponding to the target live streaming room. The editorial content may be a photo, text content, a short video, or a preview feed of a live streaming room.

The preview feed of the target live streaming room is a live streaming picture of the target live streaming room, and a viewer enters the target live streaming room by tapping the preview feed.

Specifically, if determining that the current display content is the preview feed of the target live streaming room, the client performs S350, or otherwise, performs S360.

At S350, the preview feed of the target live streaming room is deleted, or the preview feed of the target live streaming room is replaced with a preview feed of another live streaming room different from the target live streaming room.

It may be understood that if the target live streaming room is switched from the live state to the offline state and the current display content is the preview feed of the target live streaming room, in a manner of deleting the preview feed, the viewer is kept from entering an actually closed live streaming room in a manner of tapping the preview feed, or the client may replace the preview feed of the target live streaming room with the preview feed of the other live streaming room, such that the viewer enters the other live streaming room in a manner of tapping the preview feed of the other live streaming room, thereby maximizing the overall effect of multiple live streaming rooms in a live streaming system.

At S360, live streaming room information of the target live streaming room is deleted, and a display state of a state identifier of the target live streaming room is adjusted to an offline display state.

In an embodiment of the present disclosure, optionally, the “a display state of a state identifier of the target live streaming room is adjusted to an offline display state” in S360 includes: deleting a live state element that has been added to a basic element of the state identifier of the target live streaming room to form a state identifier corresponding to the offline display state.

In one case, if the state identifier is a streamer avatar of the target live streaming room and a breathing light with a deformable effect and a “live” field have been added to the streamer avatar of the target live streaming room, the breathing light and the “live” field are deleted to form a streamer avatar corresponding to the offline display state.

In another case, if the state identifier is a live streaming post of the target live streaming room, and the “live” field has been added to a live streaming room nickname of the target live streaming room, and/or a red identifier is added to the live streaming room nickname of the target live streaming room, the “live” field and/or the red identifier are deleted to form the streamer avatar corresponding to the offline display state.

It may be understood that if the current display content is not the preview feed of the target live streaming room, the live streaming room information may be reset in a manner of deleting the live streaming room information, and the live state element that has been added to the basic element of the state identifier of the target live streaming room is deleted, to obtain the state identifier corresponding to the offline display state, thereby keeping the viewer from entering an actually closed live streaming room in a manner of tapping the state identifier, which is conducive to improving user experience.

In yet another implementation of the present disclosure, in a different scenario, a subscription relationship between the client and the server is generated, such that the client receives, based on the subscription relationship, live-streaming status change information of the target live streaming room pushed by the server, and determines state switching of the target live streaming room based on the live-streaming status change information.

Based on the embodiment described above, before S210 is performed, the method further includes the following steps.
At S201: the live-streaming status change information of the target live streaming room pushed by the server is received. The live-streaming status change information is pushed by the server based on a subscription relationship between a streamer of the target live streaming room and the client.
At S202: based on the live-streaming status change information, whether the target live streaming room is switched from the offline state to the live state is determined.

The live-streaming status change information is prompt information generated by the server based on a status change of the live streaming room, and is used for prompting the client to process the display state of the state identifier of the live streaming room. Optionally, the live-streaming status change information may be information indicating switching from offline to live or may be information indicating switching from live to offline.

Specifically, the live-streaming status change information may carry a live streaming room keyword and state switching information of the target live streaming room, determine the target live streaming room from multiple live streaming rooms based on the live streaming room keyword, and determine, based on the state switching information, that the target live streaming room is switched from the offline state to the live state or is switched from the live state to the offline state. Optionally, the live streaming room keyword may be a live streaming room identifier account (e.g., a live streaming room ID).

In this embodiment, optionally, the method for determining the subscription relationship includes: sending a subscription request for at least one live streaming room to the server in response to a refresh operation on a live streaming room on a current interface; receiving at least one live streaming room pushed by the server based on the subscription request; and generating the subscription relationship based on a live streaming room identifier of the at least one live streaming room and a client identifier of the client, and sending the subscription relationship to the server.

In this embodiment, when the viewer taps an application icon of a live streaming application to enable the live streaming application to cold start, or when the viewer taps a homepage of the live streaming application, the client obtains a refresh operation on a live streaming room on the current interface, and sends a subscription request to the server based on the refresh operation to enable the server to push at least one live streaming room to the client, and the client may generate the subscription relationship using the live streaming room identifier of the at least one live streaming room and the client identifier of the client, and send the subscription relationship to the server.

As described above, the current interface is a Local page, a Recommendations page, or a Following page of the live streaming application. In addition, the current interface may display the display content of one live streaming room in a display manner of a single-column information flow, or may display the display content of multiple live streaming rooms in a display manner of a multi-column information flow. This is not limited herein.

The display content of the live streaming room is editorial content corresponding to the live streaming room. The editorial content may be text content, a short video, or a preview feed of a live streaming room.

The live streaming room identifier of the live streaming room is identifier information used for distinguishing between different live streaming rooms, and may specifically include, but is not limited to, a streamer nickname, a streamer account, or another streamer identifier.

The client identifier is identifier information used for distinguishing between clients of different viewers, and may include, but is not limited to, a device name.

Further, after generating the subscription relationship, the client may send the subscription relationship to the server over a persistent connection to enable the server to store the subscription relationship and enable the server to push, when generating the live-streaming status change information of the target live streaming room, the live-streaming status change information of the target live streaming room to the client based on the subscription relationship and over the persistent connection. When receiving the live-streaming status change information of the target live streaming room pushed by the server and determining that the target live streaming room is switched from the offline state to the live state, the client adjusts the display state of the state identifier of the target live streaming room to the live display state in a manner of sending the liveness probe request to the server, making it convenient for the viewer to enter the target live streaming room based on the state identifier in the live display state to watch a live stream, thereby helping improve the live-streaming effect.

In some cases, after opening a short video application, the viewer is accustomed to switching between live streaming rooms in a manner of swiping down or up. After the subscription relationship is generated in the foregoing manner, in the method, the subscription relationship is updated in real time, and the updated subscription relationship is sent to the server to enable the server to re-push live-streaming status change information of the target live streaming room to the client based on the updated subscription relationship. Based on the re-pushed live-streaming status change information of the target live streaming room and based on a manner of resending the liveness probe request, the client adjusts the display state of the state identifier of the target live streaming room from the offline display state to the live display state or adjusts the display state of the state identifier of the target live streaming room from the live display state to the offline display state. Correspondingly, after the subscription relationship is generated, the method further includes: when a swipe operation on the live streaming room on the current interface is detected, determining, based on a swipe direction and a swipe count of the swipe operation, a quantity of live streaming rooms that have been swiped away on the current interface; and regenerating a subscription relationship based on the quantity of live streaming rooms that have been swiped away and the swipe direction, and sending the regenerated subscription relationship to the server.

The swipe direction includes a swipe-down direction from a top of the current interface to a bottom of the current interface, and a swipe-up direction from the bottom of the current interface to the top of the current interface. The swipe count is a swipe-down count and/or a swipe-up count. Therefore, based on the swipe direction and the swipe count, the quantity of live streaming rooms that have been swiped away may be determined.

In this embodiment, optionally, the regenerating a subscription relationship based on the quantity of live streaming rooms that have been swiped away and the swipe direction, and sending the regenerated subscription relationship to the server specifically includes: if the swipe direction is a swipe-down direction pointing from a top of the current interface to a bottom of the current interface and the quantity of live streaming rooms that have been swiped away is a first quantity, regenerating a subscription relationship based on the live streaming room identifier of the at least one live streaming room, a live streaming room identifier of at least one live streaming room to be displayed after a swipe-down, and the client identifier; and/or if the swipe direction is a swipe-up direction pointing from a bottom of the current interface to a top of the current interface and the quantity of live streaming rooms that have been swiped away is a second quantity, regenerating a subscription relationship based on the live streaming room identifier of the at least one live streaming room, a live streaming room identifier of at least one live streaming room to be displayed after a swipe-up, and the client identifier.

The first quantity is a quantity of live streaming rooms on an interface to be displayed after a swipe-down corresponding to the current interface, and the second quantity is a quantity of live streaming rooms on an interface to be displayed after a swipe-up corresponding to the current interface. Optionally, the first quantity and the second quantity may be equal or may not be equal.

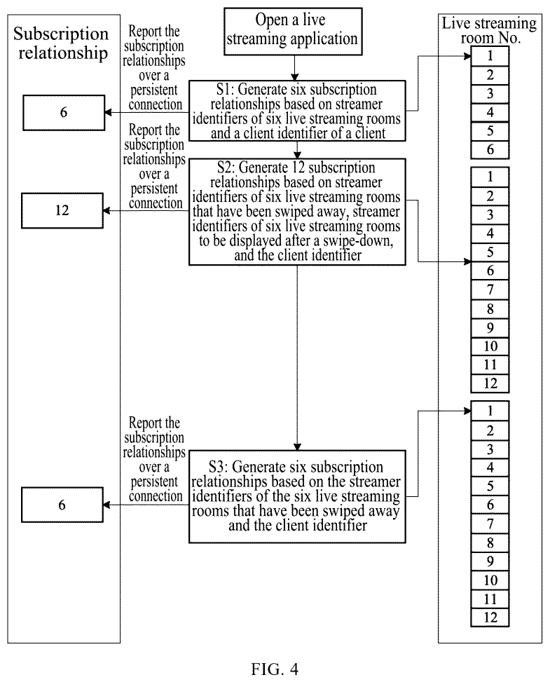

It should be noted that in some cases, when pushing a live streaming room to the client, the server can quickly push at least one live streaming room during a swipe-up or a swipe-down based on the swipe direction of the user, that is, both the first quantity and the second quantity are greater than 0. In some other cases, when pushing a live streaming room to the client, the server can only push at least one live streaming room quickly during a swipe-down. The first quantity is greater than 0, and the second quantity is greater than or equal to 0. For ease of understanding, an example in which the first quantity and the second quantity are both 6 and the current interface displays display content of one live streaming room is used to explain a process of generating the subscription relationship based on the refresh operation and updating the subscription relationship based on the swipe operation. Referring to the logical schematic diagram of a process of generating the subscription relationship shown in FIG. 4, first, when the viewer opens a live streaming application and taps a homepage of the live streaming application to refresh live streaming rooms displayed on a current page, the client obtains and responds to a refresh operation to send a subscription request for six live streaming rooms to the server. The server pushes six live streaming rooms to the client based on the subscription request. The six live streaming rooms are one live streaming room to be displayed after the current interface is refreshed and five live streaming rooms to be displayed following the live streaming room. The client generates six subscription relationships based on live streaming room identifiers of the six live streaming rooms (i.e., live streaming room identifiers of live streaming rooms Nos. 1 to 6 corresponding to S1 in FIG. 4) and the client identifier of the client, and sends the six subscription relationships to the server.

Next, when the viewer swipes on the current interface, specifically, the swipe direction is the swipe-down direction, and the quantity of live streaming rooms that have been swiped away is 6, that is, when the viewer swipes down to the sixth live streaming room, based on live streaming room identifiers (i.e., live streaming room identifiers of live streaming rooms Nos. 1 to 6 corresponding to S2 in FIG. 4) of the six live streaming rooms that have been swiped away, live streaming room identifiers (i.e., live streaming room identifiers of live streaming rooms Nos. 7 to 12 corresponding to S2 in FIG. 4) of six live streaming rooms to be displayed after a swipe-down, and the client identifier, 12 subscription relationships are regenerated, and the 12 subscription relationships are sent to the server.

Similarly, when the viewer swipes on the current interface, specifically, the swipe direction is the swipe-up direction, and the quantity of live streaming rooms that have been swiped away is 6, a subscription relationship needs to be regenerated based on live streaming room identifiers of the six live streaming rooms that have been swiped away, live streaming room identifiers of six live streaming rooms to be displayed after a swipe-up, and the client identifier. However, it is considered that when pushing a live streaming room to the client, the server can push only at least one live streaming room quickly during a swipe-down, specifically, when the quantity of live streaming rooms that have been swiped away is 6, that is, when the viewer returns to the first live streaming room, streamer identifiers of six live streaming rooms to be displayed after a swipe-up corresponding to the first live streaming room cannot be quickly obtained, and need to be obtained in a refresh manner. Therefore, six subscription relationships are regenerated based on only live streaming room identifiers (i.e., the live streaming room identifiers corresponding to live streaming rooms Nos. 1 to 6 in S3 in FIG. 4) of six live streaming rooms that have been swiped away and the client identifier, and the six subscription relationships are sent to the server.

Therefore, the client generates the subscription relationship based on the refresh operation on the live streaming rooms on the current interface by the viewer, and sends the subscription relationship to the server, and may also regenerate, when detecting the swipe operation, a subscription relationship based on the swipe direction and the swipe count of the swipe operation, and send the subscription relationship to the server, such that the server pushes the live-streaming status change information to the client based on the subscription relationship, thereby ensuring the reliability of information push.

In other cases, interface switching may be performed after the viewer opens the live streaming application, and after the interface switching, a subscription relationship is regenerated and sent. Correspondingly, after the subscription relationship is generated, the method further includes: sending, to the server in response to an interface switching operation on the current interface, a subscription request for at least one live streaming room to be displayed on a next interface; receiving at least one live streaming room re-pushed by the server based on the new subscription request; and regenerating a subscription relationship based on a live streaming room identifier of the re-pushed at least one live streaming room and the client identifier of the client, and sending the subscription relationship to the server.

The next interface is an interface determined based on an operation position of an interface switching operation by the viewer. For example, when the current interface is a Following page, the next interface may be a Featured interface, a Recommendations page, a Live Streaming Featured page, or the like.

Therefore, when the viewer performs interface switching on the client, a subscription relationship between at least one live streaming room to be displayed on the next interface and the client is regenerated, making it convenient for the server to subsequently detect, based on the subscription relationship corresponding to the next interface, the display state of the live streaming room to be displayed on the next interface.

In other cases, when the persistent connection between the client and the server is disconnected and then reestablished, a subscription relationship may be regenerated based on a live streaming room identifier of at least one live streaming room to be displayed on the current interface after the persistent connection is established and the client identifier of the client, and sent to the server.

Therefore, when the persistent connection is disconnected and reestablished, a subscription relationship is regenerated and sent, making it convenient for the server to subsequently detect, based on the subscription relationship corresponding to the current interface, the display state of the live streaming room to be displayed on the current interface.

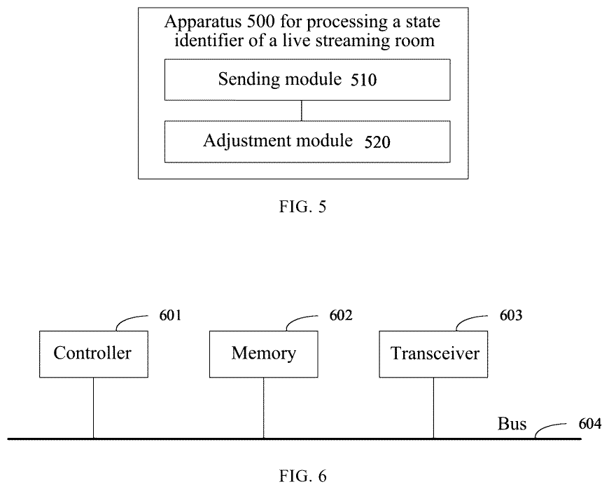

Based on the same inventive concept as the foregoing method embodiment, the present disclosure further provides an apparatus for processing a state identifier of a live streaming room. FIG. 5 is a schematic structural diagram of an apparatus for processing a state identifier of a live streaming room according to an embodiment of the present disclosure. The apparatus 500 for processing a state identifier of a live streaming room includes:
a sending module 510 configured to: when it is determined that a target live streaming room is switched from an offline state to a live state, send a liveness probe request to a server, such that the server returns live streaming room information of the target live streaming room based on the liveness probe request; and
an adjustment module 520 configured to adjust a display state of a state identifier of the target live streaming room to a live display state based on the live streaming room information of the target live streaming room.

In an optional implementation, the adjustment module 520 includes:
an addition unit configured to add a live state element to a basic element of the target live streaming room based on the live streaming room information to form a state identifier corresponding to the live display state.

In an optional implementation, the apparatus further includes:
a receiving module configured to receive live-streaming status change information of the target live streaming room pushed by the server; and
a switching determining module configured to determine, based on the live-streaming status change information, whether the target live streaming room is switched from the offline state to the live state.

In an optional implementation, the live-streaming status change information is pushed by the server based on a subscription relationship between a streamer of the target live streaming room and a client.

In an optional implementation, the apparatus further includes:
a first request sending module configured to send a subscription request for at least one live streaming room to the server in response to a refresh operation on a live streaming room on a current interface;
a first receiving module configured to receive at least one live streaming room pushed by the server based on the subscription request; and
a generation module configured to generate the subscription relationship based on a live streaming room identifier of the at least one live streaming room and a client identifier of the client, and send the subscription relationship to the server.

In an optional implementation, the apparatus further includes:
a swipe operation detection module configured to: when a swipe operation on the live streaming room on the current interface is detected, determine, based on a swipe direction and a swipe count of the swipe operation, a quantity of live streaming rooms that have been swiped away on the current interface; and
a first regeneration module configured to regenerate a subscription relationship based on the quantity of live streaming rooms that have been swiped away and the swipe direction, and send the subscription relationship to the server.

In an optional implementation, the first regeneration module is specifically configured to:
if the swipe direction is a swipe-down direction pointing from a top of the current interface to a bottom of the current interface and the quantity of live streaming rooms that have been swiped away is a first quantity, regenerate a subscription relationship based on the live streaming room identifier of the at least one live streaming room, a live streaming room identifier of at least one live streaming room to be displayed after a swipe-down, and the client identifier; and/or
if the swipe direction is a swipe-up direction pointing from a bottom of the current interface to a top of the current interface and the quantity of live streaming rooms that have been swiped away is a second quantity, regenerate a subscription relationship based on the live streaming room identifier of the at least one live streaming room, a live streaming room identifier of at least one live streaming room to be displayed after a swipe-up, and the client identifier.

In an optional implementation, the apparatus further includes:
a first request sending module configured to send, to the server in response to an interface switching operation on the current interface, a subscription request for at least one live streaming room to be displayed on a next interface;
a second receiving module configured to receive at least one live streaming room re-pushed by the server based on the new subscription request; and
a second regeneration module configured to regenerate a subscription relationship based on a live streaming room identifier of the re-pushed at least one live streaming room and the client identifier of the client, and send the subscription relationship to the server.

In an optional implementation, the apparatus further includes:
a judgment module configured to: when it is determined that the target live streaming room is switched from the live state to the offline state, determine whether current display content displayed on a current interface is a preview feed of the target live streaming room; and
a deletion or replacement module configured to: if the current display content is the preview feed of the target live streaming room, delete the preview feed of the target live streaming room, or replace the preview feed of the target live streaming room with a preview feed of another live streaming room different from the target live streaming room; and/or
an adjustment module configured to: if the current display content is not the preview feed of the target live streaming room, delete the live streaming room information of the target live streaming room, and adjust the display state of the state identifier of the target live streaming room to an offline display state.

The embodiment of the present disclosure provides an apparatus for processing a state identifier of a live streaming room. When it is determined that a target live streaming room is switched from an offline state to a live state, a liveness probe request is sent to a server, such that the server returns live streaming room information of the target live streaming room based on the liveness probe request; and a display state of a state identifier of the target live streaming room is adjusted to a live display state based on the live streaming room information of the target live streaming room. Therefore, when perceiving that the target live streaming room is switched from the offline state to the live state, the client adjusts in time the display state of the state identifier of the target live streaming room by sending the liveness probe request to the server. Therefore, the problem that a live streaming room is in fact already live but a state identifier of the live streaming room is in an offline display state is avoided, that is, the problem that the display state of the state identifier of the live streaming room does not match a real state of the live streaming room is avoided, and viewers can conveniently enter the target live streaming room based on the state identifier in the live display state to watch a live stream, thereby improving the live-streaming effect.

In addition to the method and apparatus described above, an embodiment of the present disclosure further provides a computer-readable storage medium having instructions stored therein. The instructions, when executed on a terminal device, cause the terminal device to implement the method for processing a state identifier of a live streaming room described in the embodiments of the present disclosure.

An embodiment of the present disclosure further provides a computer program product. The computer program product includes a computer program or instructions that, when executed by a processor, implement the method for processing a state identifier of a live streaming room described in the embodiments of the present disclosure.

In addition, an embodiment of the present disclosure further provides a device for processing a state identifier of a live streaming room. As shown in FIG. 6, the device for processing a state identifier of a live streaming room may include:
a processor 601, a memory 602, an input apparatus 603, and an output apparatus 604. There may be one or more processors 601 in the device for processing a state identifier of a live streaming room. For example, there is one processor in FIG. 6. In some embodiments of the present disclosure, the processor 601, the memory 602, the input apparatus 603, and the output apparatus 604 may be connected through a bus or in another manner, for example, are connected through the bus in FIG. 6.

The memory 602 may be configured to store a software program and a module. The processor 601 performs various functional applications of the device for processing a state identifier of a live streaming room and processes data by executing the software program and the module stored in the memory 602. The memory 602 may mainly include a program storage area and a data storage area. The program storage area may store an operating system, an application required by at least one function, and the like. In addition, the memory 602 may include a high-speed random-access memory, and may further include a non-volatile memory, such as at least one magnetic disk storage device, a flash memory device, or other volatile solid-state storage devices. The input apparatus 603 may be configured to receive entered numerical or character information, and generate a signal input related to a user setting and function control of the device for processing a state identifier of a live streaming room.

Specifically, in this embodiment, the processor 601 loads an executable file corresponding to a process of one or more applications into the memory 602 in accordance with the following instructions, and the processor 601 executes the application stored in the memory 602, to implement various functions of the device for processing a state identifier of a live streaming room described above.

It should be noted that the relational terms such as “first” and “second” herein are only used to distinguish one entity or operation from another, and do not necessarily require or imply that any actual relationship or sequence exists between these entities or operations. Moreover, the terms “include”, “including”, “comprise” and “comprising”, or any of their variants are intended to cover a non-exclusive inclusion, so that a process, method, article, or device that includes a list of elements not only includes those elements but also includes other elements that are not expressly listed, or further includes elements inherent to such process, method, article, or device. In the absence of more restrictions, an element defined by “including a . . . ” does not exclude another identical element in a process, method, article, or device that includes the element.

The above description illustrates merely specific implementations of the present disclosure, so that those skilled in the art can understand or implement the present disclosure. Various modifications to these embodiments are apparent to those skilled in the art, and the general principle defined herein may be practiced in other embodiments without departing from the spirit or scope of the present disclosure. Therefore, the present disclosure is not limited to the embodiments herein but is to be accorded the broadest scope consistent with the principle and novel features disclosed herein.

1. A method for processing a state identifier of a live streaming room, the method comprising:
in response to determining that a target live streaming room is switched from an offline state to a live state, sending a liveness probe request to a server, to cause the server to return live streaming room information of the target live streaming room based on the liveness probe request; and
adjusting a display state of a state identifier of the target live streaming room to a live display state based on the live streaming room information of the target live streaming room.

2. The method according to claim 1, wherein adjusting the display state of the state identifier of the target live streaming room to the live display state based on the live streaming room information of the target live streaming room comprises:
adding a live state element to a basic element of the target live streaming room based on the live streaming room information to form a state identifier corresponding to the live display state.

3. The method according to claim 1, wherein the method further comprises:
receiving live-streaming status change information of the target live streaming room pushed by the server; and
determining, based on the live-streaming status change information, whether the target live streaming room is switched from the offline state to the live state.

4. The method according to claim 3, wherein the live-streaming status change information is pushed by the server based on a subscription relationship between a streamer of the target live streaming room and a client.

5. The method according to claim 4, wherein the method further comprises:
sending a subscription request for at least one live streaming room to the server in response to a refresh operation on a live streaming room on a current interface;
receiving at least one live streaming room pushed by the server based on the subscription request; and
generating the subscription relationship based on a live streaming room identifier of the at least one live streaming room and a client identifier of the client, and sending the subscription relationship to the server.

6. The method according to claim 5, wherein after generating the subscription relationship based on the live streaming room identifier of the at least one live streaming room and the client identifier of the client, and sending the subscription relationship to the server, the method further comprises:
in response to detecting a swipe operation on the live streaming room on the current interface, determining, based on a swipe direction and a swipe count of the swipe operation, a quantity of live streaming rooms that have been swiped away on the current interface; and
regenerating a subscription relationship based on the quantity of live streaming rooms that have been swiped away and the swipe direction, and sending the subscription relationship to the server.

7. The method according to claim 6, wherein regenerating the subscription relationship based on the quantity of live streaming rooms that have been swiped away and the swipe direction comprises:
in response to the swipe direction being a swipe-down direction pointing from a top of the current interface to a bottom of the current interface and the quantity of live streaming rooms that have been swiped away being a first quantity, regenerating the subscription relationship based on the live streaming room identifier of the at least one live streaming room, a live streaming room identifier of at least one live streaming room to be displayed after a swipe-down, and the client identifier; and/or
in response to the swipe direction being a swipe-up direction pointing from the bottom of the current interface to the top of the current interface and the quantity of live streaming rooms that have been swiped away being a second quantity, regenerating the subscription relationship based on the live streaming room identifier of the at least one live streaming room, a live streaming room identifier of at least one live streaming room to be displayed after a swipe-up, and the client identifier.

8. The method according to claim 5, wherein after generating the subscription relationship based on the live streaming room identifier of the at least one live streaming room and the client identifier of the client, and sending the subscription relationship to the server, the method further comprises:
sending, to the server in response to an interface switching operation on the current interface, a subscription request for at least one live streaming room to be displayed on a next interface;
receiving at least one live streaming room re-pushed by the server based on the new subscription request; and
regenerating a subscription relationship based on a live streaming room identifier of the re-pushed at least one live streaming room and the client identifier of the client, and sending the subscription relationship to the server.

9. The method according to claim 1, further comprising:
in response to determining that the target live streaming room is switched from the live state to the offline state, determining whether display content of a current interface is a preview feed of the target live streaming room; and
in response to the display content being the preview feed of the target live streaming room, deleting the preview feed of the target live streaming room, or replacing the preview feed of the target live streaming room with a preview feed of another live streaming room different from the target live streaming room; and/or
in response to the display content being not the preview feed of the target live streaming room, deleting the live streaming room information of the target live streaming room, and adjusting the display state of the state identifier of the target live streaming room to an offline display state.

10. (canceled)

11. (canceled)

12. A device, comprising: a memory, a processor, and a computer program that is stored on the memory and executable on the processor, the processor executing the computer program, to configure the processor to:
in response to determining that a target live streaming room is switched from an offline state to a live state, send a liveness probe request to a server, to cause the server to return live streaming room information of the target live streaming room based on the liveness probe request; and
adjust a display state of a state identifier of the target live streaming room to a live display state based on the live streaming room information of the target live streaming room.

13. A computer program product, comprising a computer program or instructions which, when executed by a processor, configure the processor to:
in response to determining that a target live streaming room is switched from an offline state to a live state, send a liveness probe request to a server, to cause the server to return live streaming room information of the target live streaming room based on the liveness probe request; and
adjust a display state of a state identifier of the target live streaming room to a live display state based on the live streaming room information of the target live streaming room.

14. The computer program product according to claim 13, wherein the computer program or instructions configuring the processor to adjust the display state of the state identifier of the target live streaming room to the live display state based on the live streaming room information of the target live streaming room comprise computer program or instructions to configure the processor to:
add a live state element to a basic element of the target live streaming room based on the live streaming room information to form a state identifier corresponding to the live display state.

15. The device according to claim 12, wherein the computer program to configure the processor to adjust the display state of the state identifier of the target live streaming room to the live display state based on the live streaming room information of the target live streaming room comprises computer program to configure the processor to:
add a live state element to a basic element of the target live streaming room based on the live streaming room information to form a state identifier corresponding to the live display state.

16. The device according to claim 12, wherein the computer program further configures the processor to:
receive live-streaming status change information of the target live streaming room pushed by the server; and
determine, based on the live-streaming status change information, whether the target live streaming room is switched from the offline state to the live state.

17. The device according to claim 16, wherein the live-streaming status change information is pushed by the server based on a subscription relationship between a streamer of the target live streaming room and a client.

18. The device according to claim 17, wherein the computer program further configures the processor to:
send a subscription request for at least one live streaming room to the server in response to a refresh operation on a live streaming room on a current interface;
receive at least one live streaming room pushed by the server based on the subscription request; and
generate the subscription relationship based on a live streaming room identifier of the at least one live streaming room and a client identifier of the client, and send the subscription relationship to the server.

19. The device according to claim 18, wherein after the computer program to configure the processor to generate the subscription relationship based on the live streaming room identifier of the at least one live streaming room and the client identifier of the client, and send the subscription relationship to the server, the computer program further configures the processor to:
in response to detecting a swipe operation on the live streaming room on the current interface, determine, based on a swipe direction and a swipe count of the swipe operation, a quantity of live streaming rooms that have been swiped away on the current interface; and
regenerate a subscription relationship based on the quantity of live streaming rooms that have been swiped away and the swipe direction, and send the subscription relationship to the server.

20. The device according to claim 19, wherein the computer program to configure the processor to regenerate the subscription relationship based on the quantity of live streaming rooms that have been swiped away and the swipe direction comprises computer program to configure the processor to:
in response to the swipe direction being a swipe-down direction pointing from a top of the current interface to a bottom of the current interface and the quantity of live streaming rooms that have been swiped away being a first quantity, regenerate the subscription relationship based on the live streaming room identifier of the at least one live streaming room, a live streaming room identifier of at least one live streaming room to be displayed after a swipe-down, and the client identifier; and/or
in response to the swipe direction being a swipe-up direction pointing from the bottom of the current interface to the top of the current interface and the quantity of live streaming rooms that have been swiped away being a second quantity, regenerate the subscription relationship based on the live streaming room identifier of the at least one live streaming room, a live streaming room identifier of at least one live streaming room to be displayed after a swipe-up, and the client identifier.

21. The device according to claim 18, wherein after the computer program to configure the processor to generate the subscription relationship based on the live streaming room identifier of the at least one live streaming room and the client identifier of the client, and send the subscription relationship to the server, the computer program further configures the processor to:
send, to the server in response to an interface switching operation on the current interface, a subscription request for at least one live streaming room to be displayed on a next interface;
receive at least one live streaming room re-pushed by the server based on the new subscription request; and
regenerate a subscription relationship based on a live streaming room identifier of the re-pushed at least one live streaming room and the client identifier of the client, and send the subscription relationship to the server.

22. The device according to claim 12, wherein the computer program further configures the processor to:
in response to determining that the target live streaming room is switched from the live state to the offline state, determine whether display content of a current interface is a preview feed of the target live streaming room; and
in response to the display content being the preview feed of the target live streaming room, delete the preview feed of the target live streaming room, or replace the preview feed of the target live streaming room with a preview feed of another live streaming room different from the target live streaming room; and/or
in response to the display content being not the preview feed of the target live streaming room, delete the live streaming room information of the target live streaming room, and adjust the display state of the state identifier of the target live streaming room to an offline display state.
